(19) United States
(12) Patent Application Publication
(10) Pub. No.: US 2009/0126239 A1
(43) Pub. Date: May 21, 2009

(54) Motorized action card

(76) Inventor: Timothy Clegg, Manhattan Beach, CA (US)

Correspondence Address: LAW OFFICES OF CLEMENT CHENG, 17220 NEWHOPE STREET #127, FOUNTAIN VALLEY, CA, 92708, US

(21) Appl. No.: 11/986,220

(22) Filed: Nov. 20, 2007

(51) Int. Cl. G09F 1/00

(52) U.S. Cl. 40/124.03; 206/232; 40/124.09; 40/407; 40/455

(57) ABSTRACT

An action card device provides a compact motor drive and comprises a foldable support structure comprising means for securing a smaller card thereto; a means for emitting sounds in the foldable support structure, emitting sounds upon unfolding, the sound emitting means comprising an electronic microchip sound generating device energized by a number of onboard batteries; a slide tongue switch having two ends wherein one of the two ends is connected to the electronic microchip sound generating device and the other end is attached to the foldable support structure; and a thin electric motor mounted on the foldable support structure and connected to an output of the electronic microchip sound generating device. The power drive oscillates a mobile accessory on the card device in synchronization with the activation of the electronic microchip sound generating device at opening of the card device.

### BACKGROUND OF THE INVENTION

A. Field of the Invention

The present invention relates to a printed product. More particularly, the present invention relates to a card with voice records and motorized movements as a vehicle to promote interests in the recipients for delivering trade and other communicatory messages.

B. Description of the Prior Art

Printed card devices with an embedded audio source of microchip are known for use as a holder for smaller cards like a business card or credit card. One earlier solution was permitted to the present applicant by U.S. Pat. No. 5,275,285, which is incorporated herein for reference.

Functional cards with trigger devices for starting an electronic audio or light signal are described in U.S. Pat. Nos. 4,286,399 to Funahashi et al; 4,703,573 to Montgomery et al.; 4,791,741 to Kondo; 5,063,698 to Johnson et al.; 5,245,171 to Fox et al.; 5,761,836 to Dawson; 5,778,574 to Reuben; 6,104,306 to Hogue et al; and 6,591,523 to Pines.

Calloway et al. in U.S. Pat. No. 4,611,262 teaches an electrical circuit package for greeting cards which provides an electrical circuit via a stamped and formed lead frame supported and insulated in a dielectric housing. When activated, the electrical circuit causes a piezoelectric transducer to generate audio signals in the form of a musical tone, spoken words or both.

Because of these developments of technology, recent commercial and commemorative cards are known to include electronic sound or visual effects in more varied ways to receive focused recipients' attentions while pushing the messages more effectively to people with using pleasant surprises especially in unexpectedly smaller or thinner packages, which multiply the curiosity to the benefit of an advertiser or a presenter of many kinds. Amidst the abundant multimedia contents easily available, audiences get higher expectancy for the same duration of their attention time spent on conventional communication medium such as direct mail cards, product packaging, gift cards, promotional goods and point of purchase displays in thin sheet forms.

However, prior art message cards may have tried to reach audiences through sights, sounds, and/or smells that provided passive sensory effects but fall short in moving them through an actual movement in the cards. Literately speaking, there have been no suggestions to provide a powerful action card.

There is a demanding need for an appropriate technology to incorporate mobility into a typical audio/visual card design to result in a desirably stimulating as well as economical means for personal and public message deliveries.

An objective of the present invention is to incorporate a motorized power source into greeting cards to drive a mobile accessory on the cards to physically attract attention in an entertaining way.

Another objective of the present invention is to provide a media card taking advantage of a compact motor drive to add a flat fan that works to produce a whirlwind of air to the surrounding space for visual and tactile stimulations to the recipient.

Yet another objective of the present invention is to provide a carrier in the greeting card form for business card and/or compact electronic storage medium that plays an electronic audio message accompanied by a cooling fan action.

### SUMMARY OF THE INVENTION

In addition to delivering printed messages with an auxiliary audio message, the card device of the present invention provides a compact motor drive to extend the conventional usability of a message card. The card device comprises a foldable support structure comprising means for securing a smaller card thereto; a means for emitting sounds in the foldable support structure, emitting sounds upon unfolding, the sound emitting means comprising an electronic microchip sound generating device energized by a number of onboard batteries, and; a slide tongue switch having two ends wherein one of the two ends is connected to the electronic microchip sound generating device and the other end is attached to the foldable support structure so as to activate the electronic microchip sound generating device upon the unfolding of the foldable support structure. The card device further includes a thin electric motor mounted on the foldable support structure and connected to an output of the electronic microchip sound generating device for providing a power drive to oscillate a mobile accessory on the card device in synchronization with the activation of the electronic microchip sound generating device at opening of the card device to draw an undistracted attention of a recipient of the card device, whereby the messages are positively delivered.

In one embodiment, the mobile accessory oscillated by the motor is set of blades of a blowing fan, which is partially integrated into the foldable support structure in the form of a graphic image.

Alternatively, the rotating part is an electronic media disc loaded on a music turntable, which is integrated into the foldable support structure in the form of a graphic image and the media disc being rotated in synchronization with the activation of the electronic microchip sound generating device at opening of the card device to simulate a sample playback of an audio content stored directly in the media disc or offered indirectly through the smaller card held by the securing means, whereby promoting sales of an audio and/or video production through a trial basis assisted by the actual playback motion of the media disc.

The rotating part may be a solid wheel member of a game wheel that starts and stops in response to the opening and closing of the foldable support structure.

The sound emitting means further comprises a switch means for activating the electronic microchip sound generating device, and which is activated independent of the unfolding of the foldable support structure, such that sounds are emitted for a predetermined period of time after activation of the electronic sound generating device.

Embodiments of the invention will now be described by way of example with reference to the accompanying drawings.

### BRIEF DESCRIPTION OF THE DRAWINGS

FIG. 1 is an exploded perspective view of an action fan card according to the present invention.

FIG. 2 is an enlarged side view of the interior of card at its center fold with the half-open cover flap having a slide switch in an initial trigger position to permit a conductive arm initiate the synchronized activations of audio and motor drive sections of the card.

FIG. 3 is an enlarged cross sectional view of the card similar to FIG. 4 but the cover flap is being folded back onto the back flap to force an extension of the slide switch to break the electric contact of the conductive arm and then bring the programmed routine of audio and motor drive into silence.

FIG. 4 is a side elevational view of the interior of the action fan card of FIG. 1 showing the detailed construction of the sheet components and mounting positions of major electronic sections.

FIG. 5 is a side elevational view of the card interior with the cover flap half-open to show relative positions of the structural panels in comparison with FIG. 2.

FIG. 6 is a perspective view of an alternative embodiment of the present invention where the motor drive is utilized to turn a media disc in synchronization with the audio playback actuated by opening the card to simulate a sample playback of an audio production with action.

Similar reference numbers denote corresponding features throughout the attached drawings. Some of the call out list of elements are listed below for your convenience.
10 Motorized Action Card
12 Exterior Panel
14 Folding Line
16 First Panel Half
18 Second Panel Half
20 Audio Player
24 Microprocessor
28 Speaker
30 Battery
32 Universal Switch Board
34 Slide Tongue Switch
35 Flap Side
36 Arm
38 Bar
40 Leaf
42 Opening
44 Tail
46 Hinge Line
48 Film Sheet
52 Wire
53 Motor
56 Printed Words
60 Card
62 Motor Shaft
63 Backing Patch
64 Disk Drive
66 Fan
68 Fan Blade
70 Slot
72 First Inner Liner
74 Printed Area
78 Crimp
80 Connecting Flap
86 Vertical Flap

### DETAILED DESCRIPTION OF THE PREFERRED EMBODIMENT

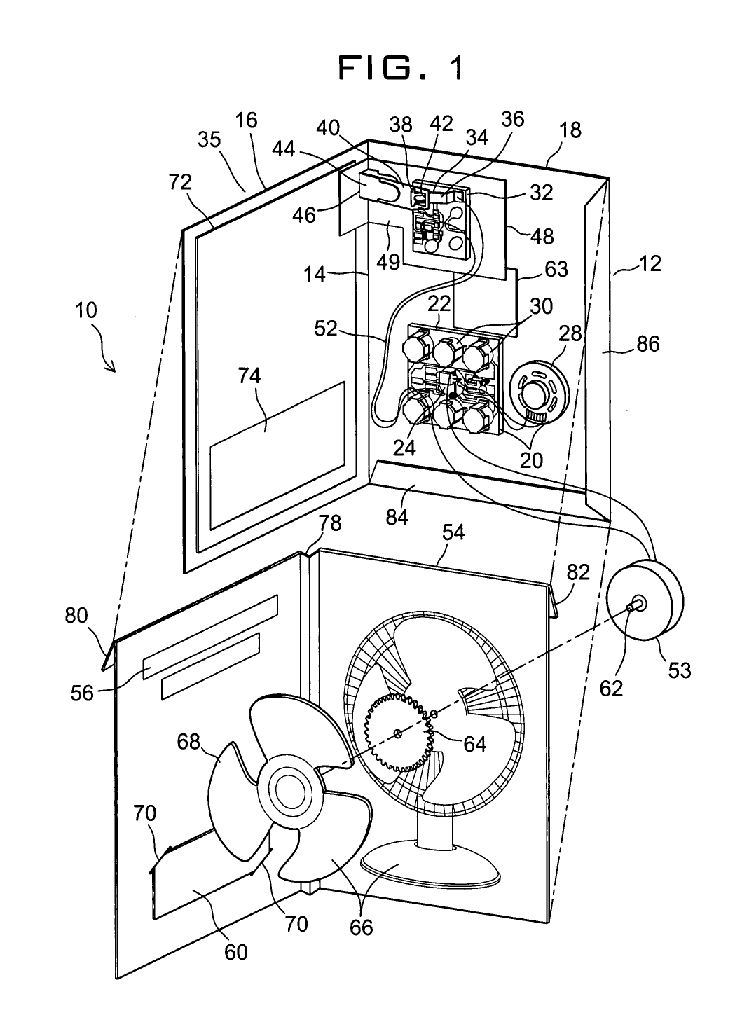

With reference to FIG. 1, a motorized action card 10 according to the present invention has an exterior panel 12 flexed at its centerfold line 14 extending vertically. Panel 12 may be made from a single sheet of material, such as coated paper stock, paper board, cardboard, paper, plastic, foil or the like. The exterior panel 12 has a first half 16 and a second half 18, an interior surface of which holds an audio emitter 20 comprising a primary circuit board 22 for mounting a microprocessor 24 of a type as used in the above-identified U.S. Pat. No. 5,275,285, i.e. Sound Generator model HT-2812 1 produced by Holtek Semiconductor Inc. of Taiwan R.O.C. or its recent equivalents. Connected to an output of the microprocessor 24 through a transistor 26 is a flat speaker 28 for playing a recorded sound of music and/or voice with the electric energy from a number of button cell batteries 30. Audio emitter 20 is activated to emit audible signal indicia (i.e. sounds, voice messages, speech, sound effects, musical melodies, tones and the like), and may be used to actively draw attention to the card messages upon opening the card 10. Preferably, the audio emitter 20 creates a sound which instills a memory cue in the recipients, so that they more readily remember the received card and retain it for longer periods of time. Therefore, the card 10 can be used as a very effective advertisement or promotional device. The sounds at the opening of card 10 may be emitted until it is folded back or may continue for a predetermined period of time after unfolding or folding the card 10.

Connected to the audio emitter 20 is a slide tongue switch 34 which acts as a trigger and is soldered to a switching board 32 to normally maintain the switch 340N state under a bias. Switch 34 is mechanically linked to a flap side 35 of card 10, which opens to break the switch 34 OFF. The tongue switch 34 may be made from coated paper stock, paper board, cardboard, plastic or the like, and may be connected to the card 10 portion by adhesives, glues or the like.

Switching board 32 is attached separately to the interior surface of the second panel half 18 has extra sets of contact terminals to extend its service to accepts other kinds of switching devices. Possible electrical switching schemes include a press activator in the shape of a small wafer dome or silkscreen printed membrane, a light sensor switch, a magnetic relay switch and a slide tongue switch 34, which is employed herein as a simple example to understand.

In further embodiments of the present invention, card 10 utilizes a user activated switch means, such as a pushbutton, a switch or like, to activate the audio emitter 20, such as a electronic microchip sound generating device, an electronic voice chip device or the like. This switch means may be used instead of or in addition to the slide tongue switch 34 described above. Activation of the switch means causes audio signals, such as sounds, voice messages, speech, sound effects, musical melodies, tones or the like, to be generated for a predetermined period of time (i.e. 10 seconds or the like), whether the card 10 is in a folded or unfolded state. Further, the card 10 may use a plurality (not shown) of audio emitter 20 to achieve a variety of audio signal combinations, not obtainable by a single chip.

The slide switch 34 includes a cantilevered flat conductive arm 36 bent in two opposite directions to form a footing soldered onto switching board 32. The other end of arm 36 is terminated by a transverse bar 38 for keeping arm 36 in sliding engagement with a flexible dielectric leaf 40 that has an end opening 42 through which arm 36 is threaded and remains therein. The other end of leaf 40 of the switch 34 is operatively connected to first panel half 16 through a linking tail 44 adapted to pivot on a hinge line 46 extending in parallel and close to centerfold line 14. Tail 44 may be made by a partial cutout of a strong film sheet 48 that can be a self-stick label blank with a release liner (not shown). Sheet 48 extends over areas of both the first and second panel halves 16, 18 of exterior panel 12 and is large enough to support switching board 32 and bind other surrounding parts. Sheet 48 also has a side extension 49 that intersects with centerfold line 14. Leaf 40 may be attached in advance to tail 44 with the liner partially removed to facilitate the subsequent bonding process of sheet 48 between panel 12 and switching board 32. When the sheet 48 is attached with slightly shifting the hinge line 46 onto the first panel half 16, sheet 48 yields easily to the folding of centerfold line 14 and provides the reciprocating leaf 40 for converting the card opening and closing into lateral translations of slide switch 34 to turn the same on and off.

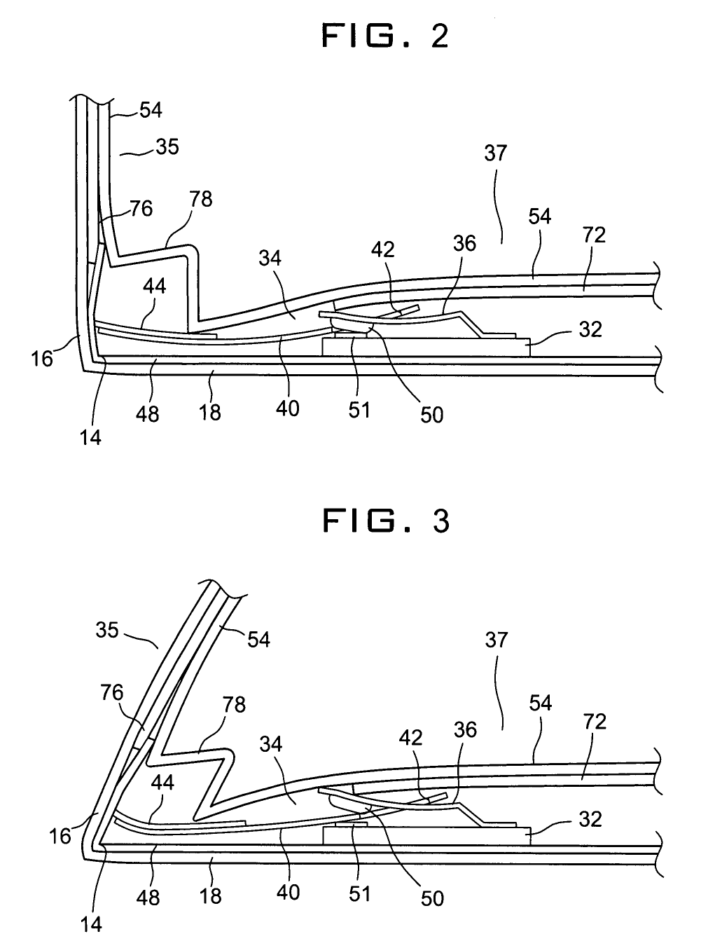

FIG. 2 shows the enlarged interior of assembled card 10 at its center fold with flap side 35 opened at about 90 degrees. Dielectric leaf 40 always engages arm 36 of switching board 32 through opening 42. A prominent contact point 50 is formed at the distal end of arm 36 to ensure a firm contact with the opposite terminal 51 on the same switching board 32 under a normal depressing bias of arm 35. As the flap side 35 pivots about centerfold line 14 pulling dielectric leaf 40 off the switching board 32, arm 36 becomes free to contact terminal 51 activating the audio/motor board 22.

Turning to FIG. 3, the flap side 35 is positioned at about 45 degrees as it is being folded back onto the back side 37. This propels leaf 40 to push arm 36 upward from terminal 51 for breaking the electric connection to the audio/motor board 22 to immediately stop the programmed routine of audio and motor drive. The elements such as the leaf 40 and the other elements such as the flaps are preferably made of paper.

Therefore, opening and closing the card 10 automatically make and break the electric power of batteries 30 of the primary board 22. Six of the button cell batteries 30 in this embodiment are each rated 1.5V and produce 4.5V total output power by connecting them in two parallel connections of three series batteries. The batteries 30 are held under the respective retention connectors soldered onto the primary board 22, which is bonded directly on the interior surface of second panel half 18 at around the center thereof. Because the switching board 32 is separately made into a lighter module to ease its precision alignment to provide the exact positions of slide switch 34 the primary board 22 may be located freely inside the card 10 with relatively low tolerance.

Two wires 52 conveniently connect the terminals of switch 34 to a positive terminal of the series batteries 30 and a power terminal of microprocessor 24. In addition, the same positive terminal of batteries 30 is connected to one of two terminals of a motor 53, the other terminal of which is connected via transistor 26 to a timed signal output of microprocessor 24 in order to synchronize the motor drive with the operation of the audio emitter 20. Motor 53 is a low-profile DC motor that may operate on 1.5-6V and dimensioned approximately 1″ diameter×0.42″ thick. An ironless printed circuit motor can fit the requirements of the motor 53 because it has a compact and lightweight construction and reaches the target speed quickly without needing a high inertia.

An interior panel 54 provides printing surfaces for displaying words 56 and graphics 58 as well as mounts for a removable 3.5″×2″ card 60 such as a business, gift, credit or membership card and motor 53. Motor 53 is firmly glued to a rear surface of panel 54 with its shaft 62 penetrating the wall of panel 54 at a clear interior space formed between switching board 32 and audio emitter 20 when two panels 12 and 54 are joined. At the corresponding position of second panel half 18 to the rear of motor 53, there is provided a backing patch 63 to help support the motor 53. Then, a disc drive 64 in the shape of a gear with a diameter corresponding to motor 53 is press fitted onto motor shaft 62 to provide a large rotating wheel hub. In this embodiment, the mobile accessory of choice is a real/virtual electric fan 66 where three integral fan blades 68 are adhered to a front surface of disc drive 64 and a graphic image or photo of an actual electric fan may take the place of the rest of fan 66 to simulate the same. Fan blades 68 are made of a piece of the same sheet material as used to make the panels 12, 54 and may be provided with colors matching the fan color of choice. In addition to the color printing, an aromatic substance may be added to the moving blades 68 using the known technology in the field of advertising by applying on the front surface of internal panel 54 a fragrant releasable by friction of edges of blades 68 scraping the treated regions of panel 54 as they move the wind toward the card recipient. A method of providing a friction-release fragrant is disclosed in U.S. Pat. No. 4,847,124 to Andrieux. As long as it can be linked to motor shaft 62 to start to make oscillating motions when the card 10 becomes unfolded, the mobile accessory is not necessarily limited to a fan design. The motorized card of the present invention may be used to drive sales of music and/or video productions simply by replacing the fan blades with a rotatable media disc with an appropriate change of the graphic image of electric fan into a CD or DVD player. More detailed descriptions will be provided below.

Or, the mobile accessory may be a miniaturized replica of any rotating structures that can be modified with minor changes to a windmill, watermill, or simulated game wheel for fun to encourage the recipient to open the same card more often and even share the card and its message with other people while multiplying the exposure time of the particular message.

The mount for temporarily holding the business card 60 includes a securing means, such as two diametrically opposite slots 70 formed by punching internal panel 54. Each slot 70 may be a simple slanted slit to receive an angle of card 60. Also, a punched opening (not shown) may be combined with the slit to permit a quicker insertion of the card 60. Alternatively, temporary adhesives may replace the slots 70 to hold the card 60. The removable card 60 may be photos larger than 3.5″×2″ size and lively presented to the recipient with the assistance of audio emitter 20 emitting audio signals, such as sounds, voice messages, speech, sound effects, musical melodies, tones or the like. For the same duration of the audio play, fan 66 rotates fast enough to cool the face of the recipient for pleasant refreshment with or without a fragrant substance. A card designer may incorporate the fan action to provide a synergic effect with matching copies of written words 56 and sound effect of emitter 20.

A fragrant substance could be adhered between the rotating graphic card and the surface that the rotating graphics card is mounted on. Rotation of the rotating graphic card may burst microcapsules to release scented messages to a user. Storage of scented material stored in friction burstable microcapsules is well known in the art.

Although not illustrated, card slots 70 may accompany an appropriate slot formed on internal panel 54 to insert a compact disc or other giveaway electronic medium to be held in a flat space between panels 16 and 54 for complimenting the immediate messages printed on the surfaces of card 10.

Additionally, a first inner liner 72 is adhered to the interior surface of first panel half 16 of exterior panel 12 primarily for reinforcing flap side 35 of the finished card 10. Liner 72 may be integrally formed to first panel half 16 at one of its three edges and folded over to strengthen the same. Liner 72 may have partially printed area 74 that matches the background color of internal panel 54 in order to provide an aesthetic finish to the interior space visible through the card slots 70. Internal panel 54 is reinforced with a second inner liner 76 (see FIG. 2), too. Second liner 76 may be an integral fold to internal panel 54 to reduce the number of parts to handle. During assembly, first inner liner 72 and backing patch 63 are attached and then partially overlapped by the film sheet 48 with switching board 32 mounted on it as it sticks onto the exterior panel 12. In this way, the sheet materials can be firmly set in place throughout the curing time for the sake of integrity of the card 10.

In order to provide the necessary rooms for the electronic components between the exterior and interior panels 12, 54, card 10 is specially shaped to have a number of connecting flaps and an M-shaped center crimp 78. Two identical connecting flaps 80 and 82 formed integral to the top edges of internal panel 54 are folded onto panel 54 itself and provide bonding surfaces facing toward the top inner surfaces of exterior panel 12. Two edges of second half 18 of panel 12 are terminated by complementary bottom flap 84 and side flap 86, which is folded onto panel 54 to provide a bonding surface. Thus, four edges of card 10, i.e., top flaps 80 and 82 of panel 54, bottom flap 84 of panel 12, and its proximal side flap 86 become elevated bonding areas leaving two side edges 88 and 90 of first half 16 of panel 12 which may be bonded flat to the opposing areas of internal panel 54.

In fastening two panels 12 and 54 together at the respective six peripheral edges to join, any one of the opposing bonding areas of panels 12, 54 may have adhesive applied and as in the case of connecting flaps 80 and 82 placement of adhesive may be consecutive in a single panel or discrete as with vertical flap 86 to speed up the mass production of the card 10 in a particular printing system.

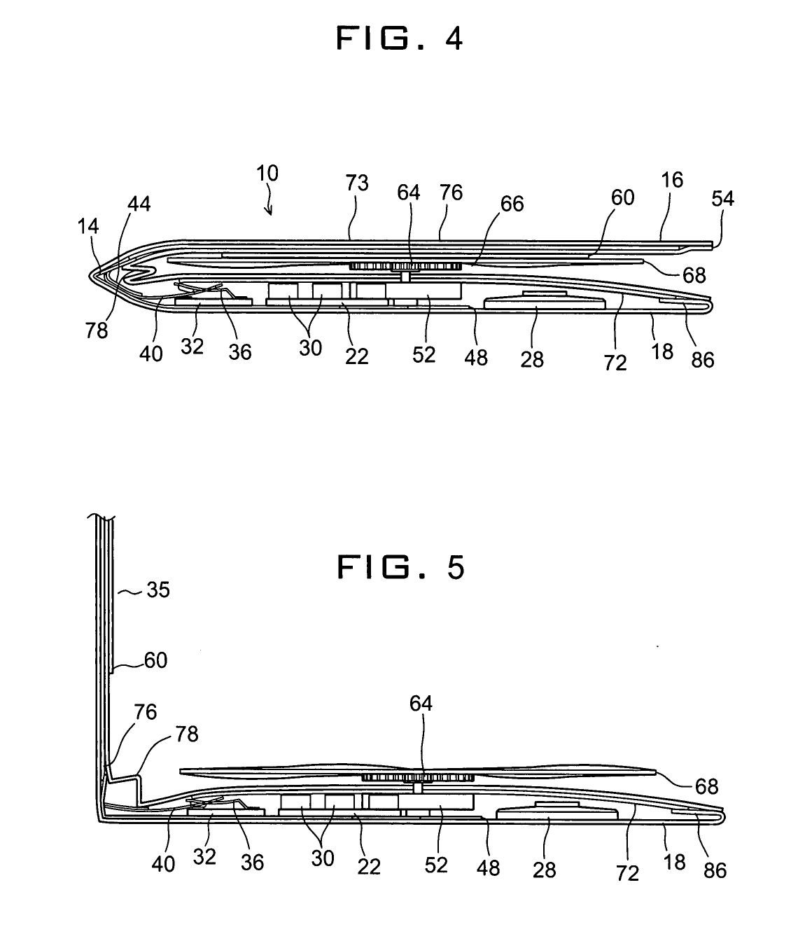

The benefit of the center crimp 78 is clear when referring to FIGS. 4 and 5 wherein two panels 16 and 54 are in juxtaposed positions except the center crimp 78 that is isolated from the smooth switching operations of slide tongue switch 34. Instead of conventionally pointing toward the centerfold line 14 of exterior panel 12, crimp 78 projects rearward to the distal ends of card 10. Further, since crimp 78 is made out of flat wall material of internal panel 54, it provides a spring force to regain its original shape which assists in flip-opening of card 10 as in FIG. 3. The drawings also show how all the electronic components may be physically arranged inside of card 10. With the largest part of fan 66 in the center, the average thickness of actual card 10 is far below half an inch though the drawings were intentionally stretched to visualize the thin layers.

Therefore, while the presently preferred form of the motorized action card has been shown and described, and several modifications thereof discussed, persons skilled in this art will readily appreciate that various additional changes and modifications may be made without departing from the spirit of the invention, as defined and differentiated by the following claims.

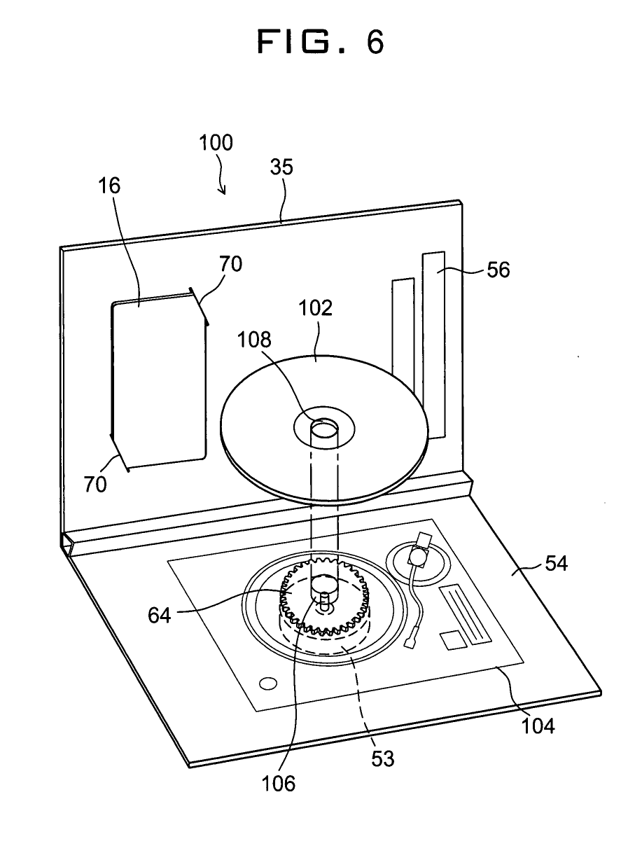

FIG. 6 depicts an example of the versatility of the inventive card structure where an action card 100 is adapted to hold and turn an electronic media disc 102 such as a CD/DVD 104 loaded on a player or turntable, which is replaced by a graphic image 104 printed on the internal panel 54. Disc drive 64 rotationally connected to motor 53 has a top elastic spindle 106 affixed concentrically to hold media disc 102 at its spindle hole 108 temporarily. Then, media disc 102 is rotated by the motor drive in synchronization with the activation of the primary audio board 22 buried in the card 100 at opening thereof to simulate a sample playback of a full audio content stored directly in the media disc 102. Alternatively, media disc 102 may hold a sample content only while the card 16 in the slots 70 may be associated with a prepay system for full downloads through computers at the convenience of home of the purchasers. In this way, the action card 100 may become an excellent means for promoting sales of audio and/or video productions through a trial basis assisted by the instant invention.

1. A card device for delivering messages with an auxiliary audio effect comprising:
a foldable support structure;
a sound emitter in the foldable support structure, emitting sounds upon unfolding, the sound emitter comprising an electronic microchip sound generating device energized by a number of onboard batteries;
a slide tongue switch having two ends wherein one of the two ends is connected to the electronic microchip sound generating device and the other end is attached to the foldable support structure so as to activate the electronic microchip sound generating device upon the unfolding of the foldable support structure; wherein the card device further includes;
a thin electric motor mounted on the foldable support structure and connected to an output of the electronic microchip sound generating device for providing a power drive to move a mobile accessory on the card device in synchronization with the activation of the electronic microchip sound generating device at opening of the card device to draw an undistracted attention of a recipient of the card device, whereby messages are positively delivered.

2. The card device according to claim 1, wherein the mobile accessory is oscillated by the motor and is a rotating part of a wheeled model figure.

3. The card device according claim 2, wherein the rotating part is a set of blades of a portable electric fan, which is partially integrated into the foldable support structure in the form of a graphic image.

4. The card device according to claim 2, wherein the rotating part is an electronic media disc loaded on a music turntable, which is integrated into the foldable support structure in the form of a graphic image and the media disc being rotated in synchronization with the activation of the electronic microchip sound generating device at opening of the card device to simulate a sample playback of an audio content stored directly in the media disc or offered indirectly through the smaller card held by a securing member.

5. The card device according to claim 2, wherein the rotating part is a solid wheel member of a game wheel that starts and stops in response to the opening and closing of the foldable support structure.

6. A card device for delivering printed messages with an auxiliary audio effect comprising:
a foldable support structure having imprinted graphic images, wherein the a foldable support structure folds at a folding line;
a small card secured to the foldable support structure;
a speaker mounted on the foldable support structure, emitting sounds upon unfolding of the foldable support structure;
an electronic microchip, storing and playing sound via the speaker upon unfolding of the foldable support structure;
a battery mounted on the small card, wherein the battery powers the electronic microchip;
a slide tongue switch having two ends wherein a first end is connected to the electronic microchip and the second end is attached to the foldable support structure so as to activate the electronic microchip sound generating device upon the unfolding of the foldable support structure, wherein the card device further includes;
a thin electric motor mounted on the foldable support structure and connected to an output of the electronic microchip sound generating device for providing a power drive to move a mobile accessory when the electronic microchip is activated.

7. The card device according to claim 6, wherein the mobile accessory oscillated by the motor is a rotating part of a wheeled model figure.

8. The card device according claim 7, wherein the rotating part is a set of blades of a portable electric fan, which is partially integrated into the foldable support structure in the form of a graphic image.

9. The card device according to claim 7, wherein the rotating part is an electronic media disc loaded on a music turntable, which is integrated into the foldable support structure in the form of a graphic image and the media disc being rotated in synchronization with the activation of the electronic microchip sound generating device at opening of the card device to simulate a sample playback of an audio content stored directly in the media disc or offered indirectly through the smaller card held by the securing means.

10. The card device according to claim 7, wherein the rotating part is a solid wheel member of a game wheel that starts and stops in response to the opening and closing of the foldable support structure.

11. The card device according to claim 7, wherein the folding line extends vertically.

12. A card device for delivering printed messages with an auxiliary audio effect comprising:
a movable support structure having an exterior panel and an interior panel, wherein the exterior panel moves relative to the interior panel, wherein the movable support structure is substantially flat;
a small card secured to the movable support structure;
a printed graphic image imprinted on the movable support structure;
a speaker mounted on the movable support structure, emitting sounds upon moving of the movable support structure, wherein the speaker is relatively flat;
an electronic microchip, storing and playing sound via the speaker upon moving of the movable support structure;
at least one battery mounted on the small card, wherein the at least one battery powers the electronic microchip;
a slide tongue switch having two ends wherein a first end is connected to the electronic microchip and the second end is attached to the movable support structure so as to activate the electronic microchip sound generating device upon the moving of the movable support structure, wherein the card device further includes;
a thin electric motor mounted on the movable support structure and connected to an output of the electronic microchip sound generating device for providing power to rotate a rotating graphic card when the electronic microchip is activated, wherein the thin electric motor is relatively flat.

13. The card device according to claim 12, wherein the rotating graphic card is a circular paper card having graphic imprinted on a rotating graphic card top face.

14. The card device according to claim 12, wherein the rotating graphic card has a fragrant substance adhered between the rotating graphic card and a surface that the rotating graphics card is mounted on, wherein rotation of the rotating graphic card bursts microcapsules to release scented messages to a user.

15. The card device according to claim 12, further comprising a first inner liner adhered to the interior surface of a first panel half of the exterior panel.

16. The card device according to claim 12, wherein the motor, rotating graphic card, and slide tongue switch are mounted at least partially to the interior panel.

17. The card device according to claim 16, wherein the rotating graphic card is a circular paper card having graphic imprinted on a rotating graphic card top face.

18. The card device according to claim 16, wherein the rotating graphic card has a fragrant substance adhered between the rotating graphic card and a surface that the rotating graphics card is mounted on, wherein rotation of the rotating graphic card bursts microcapsules to release scented messages to a user.

19. The card device according to claim 16, further comprising a first inner liner adhered to the interior surface of a first panel half of the exterior panel.
